(19) United States
(12) Patent Application Publication
(10) Pub. No.: US 2011/0086281 A1
(43) Pub. Date: Apr. 14, 2011

(54) DEVICE FOR HUMIDIFYING AND HEATING A COMBUSTIBLE GAS TO BE REFORMED FOR A FUEL CELL UNIT

(75) Inventors: Johann Huber, Finsing (DE); Udo Reckels, Neuss (DE); Michael Russ, Saal An Der Donau (DE)

(73) Assignee: MTU Onsite Energy GmbH

(21) Appl. No.: 12/919,193

(22) PCT Filed: Oct. 22, 2008
(86) PCT No.: PCT/EP08/08911

§ 371 Date: Aug. 24, 2010

(30) Foreign Application Priority Data
Oct. 24, 2007 (DE) 10 2007 050 799.4

(51) Int. Cl. H01M 8/06; F02M 23/14

(52) U.S. Cl. 429/423; 261/155

(57) ABSTRACT

Device for humidifying and heating of the combustible gas being reformed for a fuel cell system, with a housing, traversed on a stipulated flow path by the combustible gas being humidified and heated, which has an inlet situated in an upper area and a more deeply positioned outlet for the combustible gas, and with a heat exchanger, which is arranged within housing and can be traversed from the bottom up in countercurrent to the combustible gas being humidified and heated by a heat transfer agent supplying the required heat, and with a device to supply water prescribed for humidified of the combustible gas. It is proposed according to the invention that the device for supplying the water prescribed for humidified include a space arranged in the lower area of housing, accommodating the water prescribed for humidified, in which the water is in thermal contact with the lower area of the heat exchanger for heating, and a steam flow path leading upward from the space for transport of water evaporated in the space to the upper area of housing, and that the stipulated flow path for the combustible gas being humidified and heated in the upper area of housing is connected to steam flow path and leads downward to outlet for the humidified and heated combustible gas separately from flow path in thermal contact with heat exchanger.

### CROSS-REFERENCE TO RELATED APPLICATIONS

Application PCT/EP2008/008911 claims priority for Application 10 2007 050 799.4 filed on Oct. 24, 2007 in Germany.

### TECHNICAL FIELD

In one embodiment, the invention concerns a device for humidifying and heating of a fuel gas being reformed for a fuel cell system. The device includes a housing traversed on a stipulated flow path by the combustible gas being humidified and heated, which has an inlet situated in an upper area and a lower-positioned outlet for combustible gas, and with a heat exchanger, which is arranged within the housing and can be traversed from the bottom up in countercurrent to the combustible gas being humidified and heated by a heat transfer agent supplying the required heat, and with a device to supply the water prescribed for humidifying of the combustible gas.

In fuel cell systems, especially in those with molten carbonate fuel cells, the combustible gas used for operation of the fuel cells is often obtained by reforming from a crude gas, the crude gas being furnished as hydrocarbon/steam mixture for reforming.

A device used for humidifying and heating of the gas being reformed for a molten carbonate fuel cell system is known from U.S. 2006/0097412 A1. The known device includes a housing traversable on a stipulated flow path by the combustible gas being humidified and heated, which has an inlet in the upper area for the combustible gas being humidified and heated and an outlet positioned lower for the then humidified and heated combustible gas. A heat exchanger is arranged within the housing, which can be traversed from the top from the bottom up in counter-current to the combustible gas being humidified and heated by a heat transfer agent that supplies the required heat. A device to supply the water used for humidifying of the combustible gas is also provided. The heat exchanger is formed by a number of heat exchanger plates arranged with mutual spacing, which can be traversed from the bottom up by the heat transfer agent. The combustible gas being humidified and heated is guided in the intermediate spaces between the heat exchanger plates in counter-current to the heat transfer agent from the combustible gas inlet on the top to the lower-positioned combustible gas outlet. The device for supplying the water used for humidifying of the combustible gas is formed by a number of thin tubes arranged horizontally in the upper area of the housing and parallel to each other, which extend into the intermediate spaces between the heat exchanger plates that guide the combustible gas, and to which the humidifying water is supplied from the outside via a distributor. The water is sprayed from the thin tubes into the intermediate spaces guiding the combustible gas and evaporated.

Devices for humidifying and heating of a combustible gas being reformed are known from Japanese Patent Abstracts JP 601 12604 A and 63260801 A, in which a shell-and-tube heat exchanger extending between an upper tube plate and a lower tube plate is provided in the housing, whose tubes are traversed from the bottom up internally by the combustible gas being humidified and heated. The water used to humidify the combustible gas is supplied above the upper tube plate and flows into the tubes of the heat exchanger downward, where it is absorbed by the upward flowing combustible gas. In the area between the tube plates, the tubes of the heat exchanger are flowed around externally by hot steam serving as heat transfer agent in countercurrent to the combustible gas flowing in the interior of the tubes.

EP 0 320 440 B1 describes a method and device for preheating of hydrocarbon/steam mixtures. Both preheating of the supplied hydrocarbons and generation and superheating of the steam and generation and preheating of a hydrocarbon gas/steam mixture then occur in a single heat exchanger. For this purpose, a heat exchanger of upright design with five zones arranged one above the other is provided, one heat exchange zone of which is prescribed for preheating the hydrocarbons and saturating them with water vapor. This heat exchange zone contains vertically arranged heat exchange tubes in the interior of the housing, in which the hydrocarbons being humidified and heated are guided upward in countercurrent to the water, which is injected on the top and flows downward into the heat exchange tubes. As heating medium, reformer product is guided on the outside from the top down over the heat exchange tubes in countercurrent to the hydrocarbons. In the known device, an additional heat exchange zone is provided directly above said zone, which is designed the same way and serves to further heat the gaseous hydrocarbons and saturate them further with water vapor until a desired water vapor concentration is reached.

A shell-and-tube heat exchanger as such is known from DE 35 02 116 A1, which includes a tube bundle arranged vertically in a housing, which is held on its ends by an upper and lower tube plate. A heating gas is passed through the interior of the tubes of the tube bundle via collecting spaces arranged above and beneath the tube plates, while a gas being heated is guided in countercurrent to it through the intermediate space between the housing of the heat exchanger and the tubes of the tube bundle.

Different methods are described finally in U.S. 2003/0027025 A1, with which hydrocarbon-containing fuel gas/steam mixtures are to be converted into a hydrogen-rich combustible gas for operation of the fuel cells.

One purpose of the invention is to create a device for humidifying and heating of a gas being reformed for a fuel cell system, which is simply designed and effective.

### SUMMARY

In one embodiment, the application is directed to a device for humidifying and heating of a combustible gas to be reformed for a fuel cell system is devised by invention with a housing traversed on a stipulated flow path by the combustible gas being humidified and heated, which has an inlet situated in an upper area and a lower-positioned outlet for the combustible gas, and with a heat exchanger, which is arranged within the housing and can be traversed from the bottom up in countercurrent to the combustible gas being humidified and heated by a heat transfer agent that supplies the required heat, and with a device to supply the water used to humidify the combustible gas. The device to supply the water provided for humidifying according to the invention includes a space arranged in the lower area of the housing accommodating the water provided for humidifying, in which the water is in thermal contact with a lower area of the heat exchanger for heating, and a steam flow path leading up ward from the space for transport of water evaporated in the space to the upper area of the housing, in which the stipulated flow path for the combustible gas being humidified and heated in the upper area of the housing is connected to the steam flow path, and leads downward to the outlet for the humidified and heated combustible gas separately from the steam flow path in thermal contact with the heat exchanger.

According to an advantageous variant of the invention, the steam flow path is formed by a channel leading upward from the space in the interior of the housing.

According to an advantageous variant, the channel forming the steam flow path is arranged centrally in the housing and the heat exchanger is arranged in an intermediate space surrounding the steam flow path.

Preferably, the intermediate space surrounding the steam flow path forms the stipulated flow path for the combustible gas being humidified and heated.

According to a modification of the invention, the intermediate space surrounding the steam flow path contains internals, through which the combustible gas being humidified and heated is necessarily guided from the inlet on the top to the lower-positioned outlet.

The internals can be formed by baffles that extend in the intermediate space enclosing the steam flow path between the channel forming the steam flow path and the housing.

It is preferably prescribed that the baffles extend over part of the periphery around the channel forming the steam flow path and are arranged offset relative to each other in height.

The baffles can have a horizontally arranged first part extending over part of the periphery around the channel forming the steam flow path.

The baffles can also have a vertically arranged second part extending over part of the height of the intermediate space enclosing the steam flow path, so that the stipulated flow path for the combustible gas being humidified and heated is designed in the form of a coil, having several stages enclosing the channel forming the steam flow path.

The heat exchanger can be formed by a shell-and-tube heat exchanger with a number of vertically extending tubes traversable by the heat transfer agent.

The tubes of the heat exchanger can be arranged vertically penetrating the baffles in the intermediate space enclosing the steam flow path and forming the stipulated flow path for the combustible gas being humidified and heated.

Preferably, the tubes of the heat exchanger are arranged extending between a lower tube plate and an upper tube plate and sealed relative to the tube plates, in which the tube plates, together with hoods provided on the lower and/or upper end of the housing, form a collecting space on the inlet side and on the outlet side for the heat transfer agent flowing through the tubes of the heat exchanger.

According to an advantageous variant of the invention, the space serving to accommodate the water provided for humidifying is provided above the lower tube plate and is heatable through the lower area of the tubes of the heat exchanger, which run through the space, starting from the lower tube plate.

The space can have an upper wall, which borders it on the flow path for the combustible gas being humidified and heated, and which has an opening, at which the channel forming the steam flow path is connected to the space.

According to a modification of the invention, a lower area of the flow path for the gas being humidified and heated is designed as a steam/condensate collector.

According to an advantageous variant of the invention, the heat exchanger is connected to a cathode output of the fuel cell system to accommodate hot cathode gas serving as heat transfer agent.

### BRIEF DESCRIPTION OF THE DRAWINGS

FIG. 1 is a schematic representation of one embodiment of a device for humidifying and heating fuel gas being reformed for a fuel cell system.

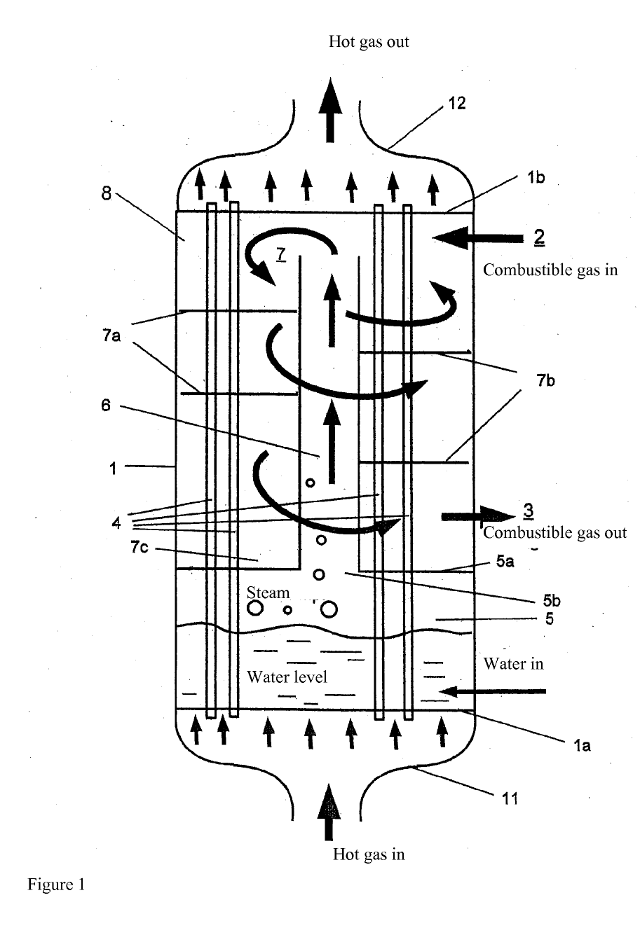

### DETAILED DESCRIPTION

Turning now to the drawings wherein like numbers refer to like structures, FIGURE shows a vertical cross-section through a device for humidifying and heating of a combustible gas being reformed for a fuel cell system according to a practical example of the invention in a somewhat schematized view.

The device depicted in the figure includes a housing 1, within which a stipulated flow path 7 for a combustible gas being humidified and heated is provided, which leads form an inlet 2 for the combustible gas being humidified and heated in the upper area of housing 1 to a lower-positioned outlet 3 for the then humidified and heated combustible gas. The stipulated flow path 7 for the combustible gas is bounded by housing 1 on one side and a channel on the other side, which is arranged centrally in the interior of housing 1 and forms a steam flow path for steam that serves to humidify the combustible gas fed at inlet 2. The water provided for humidifying is contained in a space 5, which is provided in the lower area of the device. This space 5 is bounded by an upper wall 5a, which borders it relative to flow path 7 for the combustible gas being humidified and heated, and which has an opening 5b, at which said channel forming the steam flow path 6 is connected to space 5.

A heat exchanger 4, which is arranged within housing 1 and can be traversed from the bottom up in countercurrent to the combustible gas being humidified and heated by a heat transfer agent supplying the required heat, is formed by a shell-and-tube heat exchanger, which contains a number of vertically extending tubes traversable by the heat transfer medium. As is apparent from the figure, the tubes of heat exchanger 4 are arranged extending between a lower tube plate 1a and an upper tube plate 1b and sealed relative to tube plates 1a, 1b.

The space 5 used to accommodate the water provided for humidifying is provided above the lower tube plate 1a and can be heated through the lower area of the tubes of the heat exchanger 4, which run upward through space 5, starting from lower tube plate 1a.

The tube plates 1a, 1b form, together with hoods 11, 12, provided on the lower and upper end of the housing 1, a collecting space on the inlet side and outlet side for the heat transfer agent flowing from the bottom up through the tubes of heat exchanger 4.

The prescribed flow path 7 for the combustible gas being humidified and heated is connected in the upper area 8 of housing 1 to the steam flow path formed by the channel 6 leading upward from space 5 and then leads downward to outlet 3 separately from steam flow path 6 in thermal contact with the tubes of heat exchanger 4, where the humidified and heated combustible gas is released. The stipulated flow path 7 for the combustible gas being humidified and heated, which is bounded on the outside by housing 1 and on the inside by the channel 6 forming the steam flow path, contains internals in the form of baffles 7a, 7b, through which the combustible gas being humidified and heated is necessarily guided in spiral fashion from the inlet 2 on the top to the more deeply positioned outlet 3. The baffles 7a, 7b extend in the stipulated flow path 7 for combustible gas between the channel 6 forming the steam flow path and the housing 1 over the entire width of said intermediate space. The baffles 7a, 7b each extend over part of the periphery around channel 6 and are arranged offset in height relative to each other. In the depicted practical example, the baffles 7a, 7b have a horizontally arranged first part extending over part of the periphery around channel 6 and a vertically arranged second part extending over part of the height of said intermediate space, so that the stipulated flow path 7 for the combustible gas being humidified and heated is designed in the form of a coil having several stages, which guides the combustible gas necessarily from inlet 2 to outlet 3 on a unique stipulated and possible path.

The tubes of heat exchanger 4 penetrate the horizontal parts of baffles 7a, 7b within the stipulated flow path for the combustible gas formed by the intermediate space 7.

When the mixture of combustible gas and steam formed in the upper area 8 of housing 1 is guided downward via the stipulated flow path 7 in countercurrent to the transfer agent passed through the tubes of heat exchanger 4, it is increasingly superheated, so that a mixture of combustible gas and superheated steam is available at the outlet. The heat transfer agent supplied at the lower hood 11 can be available in the form of a heating gas at about 600° C., which can then make available the mixture of superheated steam and combustible gas at a temperature of, say, 500 to 550° at outlet 3.

The heat exchanger 4 can be arranged within the fuel cell system, for which it makes available the humidified and heated combustible gas, so that the input formed by the hood 11 for the heat transfer agent is connected to the cathode output of the fuel cell system, so that hot cathode waste gas serves as heat transfer agent. The sensible heat contained in the hot cathode waste gas leaving the fuel cells is thus utilized, in order to heat and humidify the fuel gas in flow path 7.

In the practical example depicted in the figure, a lower area of the flow path 7 is designed as a vapor/condensate collector 7c for the gas being humidified and heated.

The words used to describe the embodiment set forth herein are understood to be words of descript, and not words of limitation. Those skilled in the art recognized that many variations and modifications are possible without departing from the scope and spirit of the invention as set forth in the appended claims.

1. Device for humidifying and heating of a combustible gas being reformed for a fuel cell system, with a housing traversed on a stipulated flow path by the combustible gas being humidified and heated, which has an inlet situated in an upper area and a lower-positioned outlet for combustible gas, and with a heat exchanger, which is arranged within housing and can be traversed from the bottom up in countercurrent to the combustible gas being humidified and heated by a heat transfer agent supplying the required heat, and with a device to supply the water prescribed for humidifying of the combustible gas, said device for supplying the water prescribed for humidifying includes a space arranged in the lower area of housing, accommodating the water prescribed for humidifying, in which the water is in thermal contact with a lower area of the heat exchanger for heating, and a steam flow path leading upward from space for transport of the water evaporated in space to the upper area of the housing, and that the stipulated flow path for the combustible gas being humidifying and heated is connected in the upper area of the housing to the steam flow path and leads downward to outlet for the humidified and heated combustible gas in thermal contact with heat exchanger separately from the flow path.

2. Device according to claim 1, wherein the steam flow path is formed by a channel in the interior of housing leading upward from space.

3. Device according to claim 2, wherein the channel forming the steam flow path is arranged centrally in housing, and that the heat exchanger is arranged in an intermediate space enclosing the steam flow path.

4. Device according to claim 3, wherein the intermediate space enclosing the steam flow path forms the stipulated flow path for the combustible gas being humidified and heated.

5. Device according to claim 4, wherein the intermediate space enclosing the steam flow path contains internals, through which the combustible gas being humidified and heated is necessarily guided from the inlet on the top to the more deeply positioned outlet.

6. Device according to claim 5, wherein the internals are formed by baffles that extend in the intermediate space enclosing the steam flow path between the channel forming the steam flow path and housing.

7. Device according to claim 6, wherein the baffles each extend over part of the periphery of around the channel forming the steam flow path and are arranged offset in height relative to each other.

8. Device according to claim 7, wherein the baffles have a horizontally arranged first part extending over part of the periphery around the channel forming the steam flow path.

9. Device according to claim 7, wherein the baffles have a vertically arranged second part extending over part of the height of the intermediate space enclosed in the steam flow path, so that the stipulated flow path for the combustible gas being humidified and heated is designed in the form of a coil, having several stages, enclosing the channel forming the steam flow path.

10. Device according to one of the claims 1, wherein the heat exchanger is formed by a shell-and-tube heat exchanger with a number of vertically extending tubes traversable by the heat transfer agent.

11. Device according to claim 10 wherein the tubes of the heat exchanger are arranged vertically penetrating the baffles in the intermediate space enclosing the steam flow path and forming the stipulated flow path for the combustible gas being humidified and heated.

12. Device according to claim 10, wherein the tubes of the heat exchanger are arranged extending between a lower tube plate and an upper tube plate and are sealed relative to tube plates, and that the tube plates, together with hoods provided on the lower and/or upper end of housing, form a collecting space on the inlet side and outlet side for the heat transfer agent flowing through the tubes of the heat exchanger.

13. Device according to claim 12, wherein the space used to accommodate the water prescribed for humidifying is provided above the lower tube plate and can be heated through the lower area of the tubes of the heat exchanger, which run from the lower tube plate, starting from space.

14. Device according to claim 13, wherein the space (5) has an upper wall (5a), which borders it on the flow path (7) for the combustible gas being humidified and heated, and which has an opening (5b), at which the channel forming the steam flow path (6) is connected to space (5).

15. Device according to one of the claims 1, wherein a lower area of the flow path for the gas being humidified and heated is designed as a vapor/condensate collector.

16. Device according to one of the claims 1, wherein the heat exchanger is connected to a cathode output of the fuel cell system to receive hot cathode waste gas serving as heat transfer agent.
